(19) United States
(12) Patent Application Publication
(10) Pub. No.: US 2008/0099219 A1
(43) Pub. Date: May 1, 2008

(54) Hand-held power tool with adjustable handles

(76) Inventors: Stefan Schmid, Untermuehlhausen (DE); Stefan Hammerstingl, Munich (DE); Elisabeth Lind, Feldkirch (AT)

Correspondence Address: ABELMAN, FRAYNE & SCHWAB, 666 THIRD AVENUE, 10TH FLOOR, NEW YORK, NY, 10017, US

(21) Appl. No.: 11/796,736

(22) Filed: Apr. 27, 2007

(30) Foreign Application Priority Data
Apr. 28, 2006 (DE) 10 2006 000 207.5

(51) Int. Cl. B25D 17/04

(52) U.S. Cl. 173/90; 173/162.2

(57) ABSTRACT

A hand-hand power tool (2), particularly in the form of a hammer drill or chisel hammer, has a driving unit (10) for applying blows to a working tool receptacle (20) along an operational direction (R), an outer housing (8) in which the driving unit (10) is received at least partially, and two handles (30) which are provided at opposite sides (26, 28) of the outer housing (8) and which are displaceable between different positions relative to the tool receptacle (20) for adjusting a gripping height (H), and are locked in a selected position.

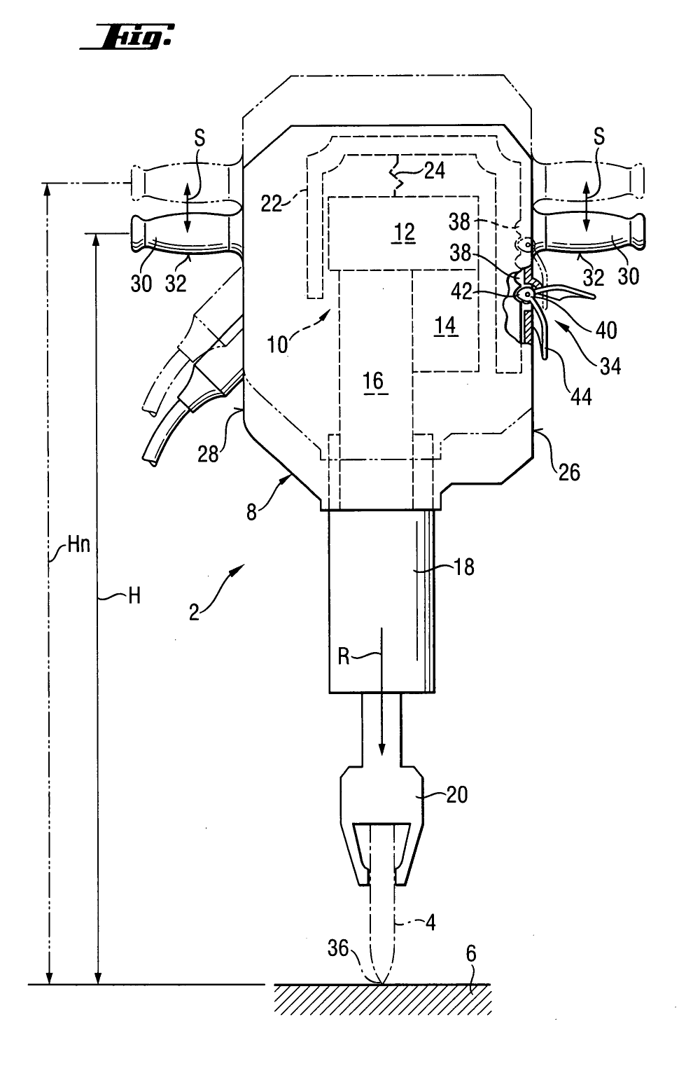

### BACKGROUND OF THE INVENTION

1. Field of the Invention

The present invention relates to a percussion hand-held power power tool which is constructed, for example, as a stand-up tool, that is, primarily for operation in a vertically downward direction while the tool user stands upright, and particularly, to an electropneumatic hammer drill or chisel hammer. It has a driving unit for applying impact energy to a tool receptacle along an operational direction and including an electric motor, possibly a gear unit, and a motion transformer in the form of a percussion mechanism. The driving unit is accommodated at least partially in an outer housing. Further, two handles are provided at opposite sides of the outer housing and can be fixed in different positions relative to the working tool receptacle for adjusting the gripping height. The gripping height is defined by the distance, parallel to the operational direction, from the handles to a tip of the working tool held in the tool receptacle.

2. Description of the Prior Art

Adjustable handles of the type mentioned above make it possible to adapt the hand-held power tool and its gripping height to the respective physical size of a user, to spatial conditions, or to different applications.

EP 0 837 757 B1 discloses a percussion power tool having a percussion mechanism in the tool housing. The tool housing is partially enclosed by a protective casing. A holding rod assembly is held at the tool housing by two flanges projecting through the protective casing and by vibration-damping means. In addition, two handles are provided at opposite sides of the holding rod assembly. To adapt the height of the handles in operation to different physical sizes of the user, a plurality of fastening holes are provided at both sides of the rod assembly, and the handles can be screwed into these fastening holes selectively.

In this way, the known percussion power tools allow users of different physical sizes to hold the percussion tool comfortably during operation.

However, a disadvantage in the known percussion tool consists in that the respective screw connection to the holding rod assembly must first be detached before adjusting the two handles and must then be restored in the new position. It is also necessary for the user to have available proper tools. There is also a risk that the two handles will unintentionally be adjusted at different gripping heights.

Further, due to the fact that the holding rod assembly is held at the tool housing in a flexible manner and projects through the protective casing, there is a risk that the user will be pinched between the holding rod assembly and the corresponding openings of the protective casing, or that dirt will penetrate through these openings and impair the operation of the percussion tool.

It is an object of the present invention to avoid the disadvantages mentioned above in a hand-held power tool and to change the handles in a comfortable manner to conform to the person, situation or application.

### SUMMARY OF THE INVENTION

This and other objects of the present invention, which will become apparent hereinafter, are achieved by mounting the handles so as to be displaceable between a plurality of positions relative to the working tool receptacle, and can be locked in a selected position. The displaceable mounting of the handles makes it possible to adjust the gripping height in a more comfortable manner. In addition, the handles can be held at the hand-held power tool in such a way that they cannot be lost.

A guide for the displaceable handles is advantageously provided at the driving unit. For example, a housing of the driving unit or an intermediate carrier that is held at the driving unit so as to be fixed or so as to reduce vibrations can serve as a direct or indirect guide for the handles. This unit of the guide at the driving unit ensures a good power flow between the driving unit and the handles during operation, which facilitates a good grip of the hand-held power tool by the user.

The guide is preferably formed by an intermediate carrier which is held at the driving unit so as to reduce vibrations. The vibration-reducing suspension can be formed by spring elements, for example. In this way, apart from the ability to adjust the gripping height, it is also possible to ensure an operation of the hand-held power tool with reduced vibrations.

The two handles preferably have a fixed connection so that they are jointly adjusted and fixed. This ensures that the two handles have a matching gripping height at all times. In addition, the connection means can be simplified.

In a particularly preferred embodiment form, the fixed connection is formed by a permanent connection of the two handles to the outer housing. For example, the handles can be constructed integrally with the outer housing at least in some areas of its outer side. In this way, the outer housing can be constructed so as to be closed almost completely in order to prevent dirt and dust from penetrating into the hand-held power tool and damaging it.

In an advantageous manner, locking means are provided between the fixed connection of the handles and the driving unit for locking the handles in a selected position. By arranging the locking means at the fixed connection, the two handles are fixed by the same locking means, which reduces production costs associated with the connection of the handles.

The locking means preferably have a plurality of locking receptacles on the drive side into which a locking member on the handle side can project at least partially in an active position for producing a positive engagement. In this way, the handles can be fixed relative to the driving unit in an especially stable manner.

The locking member is advantageously formed by an eccentric element which can be adjusted by means of a hand lever between an active position and a passive position in which the positive engagement is canceled. In this way, locking can be canceled quickly without tools so that a new position of the handles can be adjusted equally as quickly without the use of tools.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The SINGLE FIGURE of the drawings shows a side, partially cross-sectional view of a hand-held power tool according to the present invention.

### DETAILED DESCRIPTION OF THE PREFERRED EMBODIMENT

The drawing shows a hand-held power tool 2 in the form of an electropneumatic chisel hammer. The hand-held power tool 2 is constructed as a stand-up tool and is supported during operating by a working tool 4 in vertical direction against a substrate 6 to be machined and is usually held by a user, not shown, so as to be oriented substantially vertically.

The hand-held power tool 2 has an outer housing 8 in which a driving unit, designated in its entirety by reference numeral 10, is partially accommodated. This driving unit 10 has an electrically operating motor 12, a gear unit 14, and a striking mechanism 16. This striking mechanism 16 acts on a working tool receptacle 20 which is held at a guide tube 18 and in which the working tool 4 is held in a working direction R.

An intermediate carrier 22 is held at the driving unit 10 by a vibration-reducing device 24 which is shown schematically as a spring. This intermediate carrier 22 functions as a guide relative to the outer housing 8 which is held at the intermediate carrier 22 so as to be displaceable parallel to the working direction R of the hand-held power tool 2. Alternatively, the outer housing 8 can also be guided directly by a housing area of the driving unit 10.

A handle 30 projects out on a first side 26 of the outer housing 8 and on a second side 28 of the outer housing 8 remote of the first side 26. The two handles 30 have a surface 32 which is produced in one piece with the outer housing 8, for example, by joint diecasting. In this way, the two handles 30 are fixedly connected to one another by the outer housing 8 and are mounted by means of the latter at the intermediate carrier 22 so as to be jointly displaceable.

Further, locking means, designated in their entirety by 34, are provided at the first side 26 of the outer housing 8 between the latter and the intermediate carrier 22, The outer housing 8 can be secured to the intermediate carrier 22, and therefore also relative to the driving unit 10, by means of these locking means 34. Because of the fixed connection of the two handles 30 to the outer housing 8, it is sufficient to provide locking means 34 in only one area, as in the present instance at one side 26, because both handles 30 are secured simultaneously by these locking means 34.

The distance between the handles 30 and the tool receptacle 20 and therefore also an effective gripping height H during operation, which is given by the distance, parallel to the working direction R, of the handles 30 from a tip 36 of the working tool 4, can be adjusted by the locking means 34.

The locking means 34 has a plurality of locking receptacles 38 arranged one behind the other in the operational direction R at the intermediate carrier 22. An eccentric element 20 is mounted at the outer housing 8 so as to be rotatable. An eccentric cam which functions as a locking member 42 is formed at the eccentric element 40. For this purpose, the eccentric element 40 is adjustable by means of a hand lever 44 between an active position, shown in the drawing, in which the locking member 42 projects into one of the locking receptacles 38, and a passive position, shown with a dash-dot line, in which the eccentric element 40 does not engage any of the locking receptacles 38.

In the drawing, the handles 30 are secured by the locking means 34 in a position in which the gripping height H has a minimum value. For the purpose of adapting the device, for example, to a physical size of the user, to certain spatial circumstances, or to a determined type of application requiring a higher gripping height H, the eccentric element 40 is moved into the passive position by actuating the hand lever 44. The outer housing 8 can then be displaced into a new position relative to the intermediate carrier 22 corresponding to a desired new gripping height Hn as is illustrated by arrow S and the dot-dash line.

In this new position at gripping height Hn, the eccentric element 40 is then swiveled by the hand lever 44 into the active position again in which the locking means 34 again produce a positive engagement between the outer housing 8 and the intermediate carrier 22 which acts parallel to the working direction R in order to secure the new relative position of the handles 30 relative to the driving unit 10 and the tool receptacle 20.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool (2), comprising a driving unit (10) for applying blows to a working tool receptacle (20) along an operational direction (R); an outer housing (8) for at least partially receiving the driving unit (10); two handles (30) which are provided at opposite sides (26, 28) of the outer housing (8) and which are displaceable between different positions relative to the working tool receptacle (20) for adjusting a gripping height (H); and means for fixing the two handles (30) in a selected position.

2. A hand-held power tool (2) according to claim 1, further comprising a guide for the displaceable handles (30) provided at the driving unit (10).

3. A hand-held power tool (2) according to claim 2, wherein the guide is formed by an intermediate carrier (22) which is held at the driving unit (10) by vibration-reducing means.

4. A hand-held power tool (2) according to claim 1, wherein the two handles (30) have a fixed connection.

5. A hand-held power tool (2) according to claim 4, wherein the fixed connection is formed by a permanent connection of the two handles (30) to the outer housing (8).

6. A hand-held power tool (2) according to claim 4, wherein locking means (34) is provided between the fixed connection of the handles (30) and the driving unit (10).

7. A hand-held power tool (2) according to claim 6, the locking means (34) has a plurality of locking receptacles (38) on a drive side into which a locking member (42) on a handle side can project at least partially in an active position for producing a positive engagement.

8. A hand-held power tool (2) according to claim 7, wherein the locking member (42) is formed by a eccentric element (40) which can be adjusted by a hand lever (44) between the active position and a passive position in which the positive engagement is canceled.
